(19) United States
(12) Patent Application Publication
(10) Pub. No.: US 2022/0197987 A1
(43) Pub. Date: Jun. 23, 2022

(54) BIOMETRIC IDENTIFICATION THROUGH INTRA-BODY COMMUNICATION

(71) Applicant: The Regents of the University of California, Oakland, CA (US)

(72) Inventors: Ahmed Eissa Fathy Khorshid, Oakland, CA (US); Ahmed Mohamed Eltawil, Oakland, CA (US); Roger Piqueras Jover, Brooklyn, NY (US)

(21) Appl. No.: 17/604,643

(22) PCT Filed: May 15, 2020
(86) PCT No.: PCT/US2020/033060

§ 371 Date: Oct. 18, 2021

Related U.S. Application Data
(60) Provisional application No. 62/849,309, filed on May 17, 2019.

(51) Int. Cl. G06F 21/32; G06V 40/13; G06V 40/12

(52) U.S. Cl. CPC G06F 21/32; G06F 2221/2103; G06V 40/1365; G06V 40/1306

(57) ABSTRACT

Biometric identification through intra-body communication is described. In one embodiment, a system for biometric identification includes a biometric transmitter device and a biometric receiver device. The biometric transmitter device includes at least one transmit electrode for contact with skin of an individual at a first location on the skin, and the biometric transmitter device is configured to transmit a signal through the transmit electrode and the skin. The biometric receiver device includes at least one receive electrode for contact with the skin of the individual at a second location on the skin, and the biometric receiver is configured to receive the signal through the receive electrode for biometric authentication of the individual.

### CROSS-REFERENCE TO RELATED APPLICATIONS

This application claims the benefit of U.S. Provisional Application No. 62/849,309, filed May 17, 2019, the entire contents of which is hereby incorporated herein by reference.

### GOVERNMENT LICENSE RIGHTS

This invention was made with government support under contract number 2016-R2-CX-0014 awarded by the National Institute of Justice. The government has certain rights in the invention

### BACKGROUND

Authentication is relied upon in various fields. For computing devices, systems, and environments, it is often necessary to verify the identity of an individual before permitting access to confidential data or system resources. Authentication can be achieved in various ways. One of the most common means of authentication relies upon passwords. However, passwords are considered less reliable today as the management and protection of passwords has become increasingly problematic. Malicious actors have continued to find new ways to steal, break, reset, and circumvent passwords.

Among others, biometric means of authentication have been adopted more widely over recent years. Biometric authentication relies on the unique biological characteristics of individuals for verification. Biometric authentication systems compare some type of biometric response from an individual against a stored, confirmed copy of a biometric fingerprint to confirm or refute the identity of the individual. If the biometric response and fingerprints match, authentication is confirmed. Examples of biometric authentication include retina or iris scans, fingerprint scanning, facial recognition, and voice identification.

### SUMMARY

In one example, a system for biometric identification is described. The system includes a biometric transmitter device comprising at least one transmit electrode for contact with skin of an individual at a first location on the skin. The biometric transmitter device is configured to transmit a signal through the transmit electrode and the skin. The system also includes a biometric receiver device including at least one receive electrode for contact with the skin of the individual at a second location on the skin, the biometric receiver is configured to receive the signal through the receive electrode for biometric authentication of the individual.

In one aspect, the biometric receiver device further comprises an authentication engine configured to extract a channel response from the signal. The authentication engine can compare the channel response to at least one channel fingerprint. The authentication engine can also communicate a result of a comparison between the channel response and the at least one channel fingerprint over a communications channel, among taking other actions. In some cases, the authentication engine can compare the channel response to the at least one channel fingerprint on a periodic basis.

In another aspect, the authentication engine is further configured to confirm an identity of the individual based on a determination of a sufficient match between the channel response and the at least one channel fingerprint. The authentication engine can also refute an identity of the individual based on a determination of an insufficient match between the channel response and the at least one channel fingerprint.

In one example, the system can be embodied in a wearable form factor. In another example, the system can be embodied in a point of sale (POS) terminal, an automated teller machine (ATM), a piece of equipment, an access device, or other forms of equipment or infrastructure.

In another embodiment, a process for biometric identification is described. The process includes transmitting a signal into a body of an individual at a first location on the body, receiving the signal from the body of the individual at a second location on the body, wherein the body of the individual imparts a unique channel response on the signal, and extracting a channel response of the body from the signal. The process can also include performing a biometric identity challenge using the channel response, and communicating a result of the biometric identity challenge over a communications channel, among other actions.

In one aspect, the process can include performing a biometric identity challenge by comparing the channel response against at least one channel fingerprint stored in memory. Performing the biometric identity challenge can also include, based on a determination of a sufficient match between the channel response and the at least one channel fingerprint, confirming an identity of the individual. Performing the biometric identity challenge can also include, based on a determination of an insufficient match between the channel response and the at least one channel fingerprint, refuting an identity of the individual.

In another embodiment, a biometric identification device is described. The device includes at least one receive electrode for contact with skin of an individual, a signal receiver configured to receive a signal through the receive electrode, and an authentication engine. The authentication engine can be configured to extract a channel response from the signal, and compare the channel response to at least one channel fingerprint for biometric authentication of the individual. The authentication engine can also be configured to communicate a result of a comparison between the channel response and the at least one channel fingerprint over a communications channel, among other actions.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example system for biometric identification through intra-body communications according various embodiments described herein.

FIG. 2 illustrates a networked environment including the system for biometric identification shown in FIG. 1 according various embodiments described herein.

FIG. 3 illustrates a transfer function of gain versus frequency for various ages of subjects for biometric identification according various embodiments described herein.

FIG. 4 illustrates a transfer function of gain versus frequency for various body frames of subjects for biometric identification according various embodiments described herein.

FIG. 5 illustrates a transfer function of gain versus frequency for various electrodes for biometric identification according various embodiments described herein.

FIG. 6 illustrates a transfer function of gain versus frequency for various electrode positions for biometric identification according various embodiments described herein.

FIG. 7 illustrates a transfer function of gain versus frequency for various electrode positions for biometric identification according various embodiments described herein.

FIG. 8 illustrates a process for biometric identification according various embodiments described herein.

### DETAILED DESCRIPTION

As noted above, biometric means of authentication have been adopted more widely over recent years. Biometric authentication relies on the unique biological characteristics of individuals for verification. Biometric authentication systems compare some type of biometric response from an individual against a stored, confirmed copy of a biometric fingerprint to confirm or refute the identity of the individual. If the biometric response and fingerprints match, authentication is confirmed. Examples of biometric authentication include retina or iris scans, fingerprint scanning, facial recognition, and voice identification. In addition to the security provided by hard-to-fake biological traits, biometric verification can be more convenient for users because biometric traits are not easily lost or forgotten.

In the context outlined above, biometric identification through intra-body communication is described herein. In one embodiment, a system for biometric identification includes a biometric transmitter device and a biometric receiver device. The biometric transmitter device includes at least one transmit electrode for contact with skin of an individual at a first location on the skin. The biometric transmitter device is configured to transmit a signal through the transmit electrode and the skin. The biometric receiver device includes at least one receive electrode for contact with the skin of the individual at a second location on the skin. The biometric receiver is configured to receive the signal through the receive electrode for biometric authentication of the individual.

In operation, the biometric transmitter transmits a signal which propagates through at least a portion of the body of an individual. The body of the individual imparts a unique channel response on the signal, and the channel response is relied upon by the system for authentication. When the signal is received by the biometric receiver, an authentication engine of the biometric receiver is configured to extract the channel response from the signal. The authentication engine is also configured to compare the channel response to one or more channel fingerprints, in an attempt to confirm the identity of the individual based on whether or not a sufficient match occurs between the channel response and one of the channel fingerprints.

The biometric identification systems and methods described herein achieve certain advantages as compared to conventional approaches. One advantage as compared to the conventional use of fingerprint scanning as a biometric identification system, for example, is that the system can continuously or periodically authenticate individuals without the need to interfere with the activities of the individuals. The system can authenticate and re-authenticate individuals while working, exercising, and conducting other activities. With fingerprint identification, on the other hand, the person has to touch the scanner every single instance where authorization is needed. Moreover, some biometrics can be hacked or replicated, yet the biometric relied upon by the systems and methods described herein is extremely difficult to replicate.

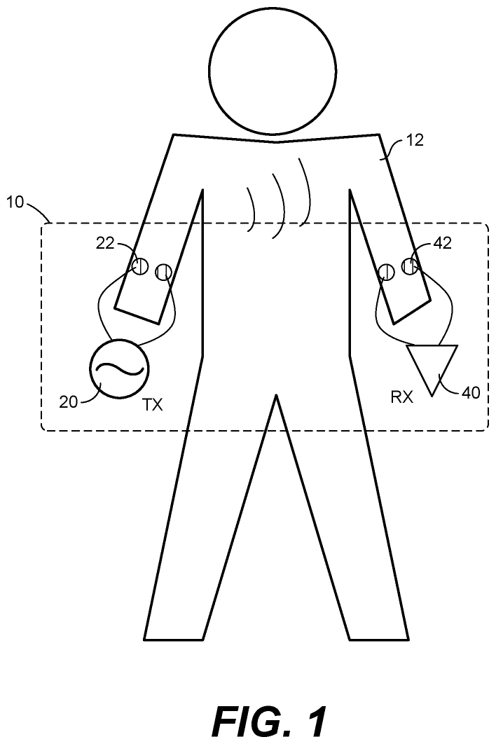

FIG. 1 illustrates an example system 10 for biometric identification through intra-body communications according various embodiments described herein. Among other components, the system 10 includes a biometric transmitter device 20 (“transmitter 20”) and a biometric receiver device 40 (“receiver 40”). The transmitter 20 is configured to generate a signal for application to or on the skin of an individual 12. The transmitter 20 also includes one or more electrodes 22, and the signal generated by the transmitter 20 is applied to the skin of the individual 12 by or through the electrodes 22.

In various implementations, the system 10 can rely upon one electrode 22 or multiple electrodes 22. The electrodes 22 can be any suitable electrodes for imparting electrical signals on and recovering electrical signals from the skin of the individual 12. The electrodes 22 can be placed at any suitable location(s) on the skin of the individual 12. In other embodiments, the electrodes 22 can be placed in or under the skin.

Once the signal generated by the transmitter 20 is applied to the skin of the individual 12, the signal can propagate through the body of the individual 12 and be received at one or more electrodes 42 of the receiver 40. Similar to the electrodes 22, the electrodes 42 can be placed at any suitable locations on, in, or under the skin of the individual 12. The electrodes 22 can also be positioned at any suitable locations with respect to the electrodes 42. Examples of positions and spacings of the electrodes 22 and the electrodes 42, individually and relative to each other, are described in further detail below.

As the signal from the electrodes 22 propagates through the body of the individual, it is exposed to a channel response inherent and unique to the individual 12. Thus, the body of the individual 12 imparts a unique channel response on the signal as it passes through the individual 12. The unique channel response is a unique biometric suitable for identification of the individual 12, and the unique channel response can is very difficult to replicate.

The receiver 40 is configured to receive the signal from the transmitter 20 at the electrodes 42. Once received, the receiver 40 is configured to extract the unique channel response of the individual from the signal. The receiver 40 is also configured to compare the channel response to one or more channel fingerprints stored in local memory on the receiver 40. The receiver 40 is able to confirm the identity of the individual 12 if a sufficient match is identified between the channel response and a channel fingerprint of the individual 12.

The system 10 can achieve certain advantages as compared to conventional approaches. One advantage is that the system 10 can continuously or periodically authenticate the individual 12 without the need to interfere with the activities of the individual 12. The system 10 can authenticate and re-authenticate the individual 12 while working, exercising, and conducting other activities, without interfering with those activities. The system 10 is also very robust against unauthorized replication and/or hacking.

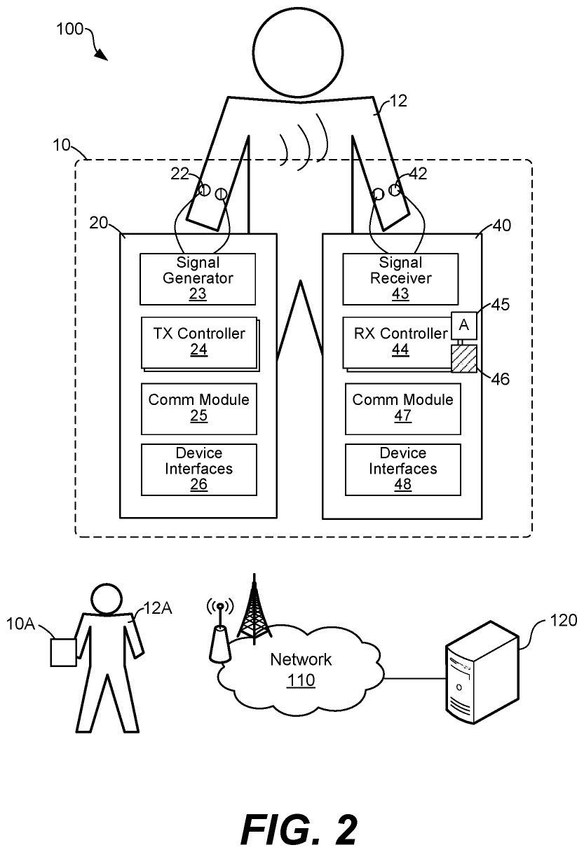

FIG. 2 illustrates a networked environment 100 including the system 10 for biometric identification shown in FIG. 1 according various embodiments described herein. The networked environment 100 is provided as a representative example for the purpose of discussion, as the system 10 can be used in other types of networked environments. The system 10 is also provided as a representative example in FIG. 2 for the purpose of discussion. The components of the system 10, as illustrated in FIG. 2, are not exhaustive. In various embodiments, the system 10 can include other elements not shown in FIG. 2, and the system 10 can omit one or more of the elements shown in FIG. 2.

Among other elements, the networked environment 100 includes the system 10 for biometric identification of the individual 12, a system 10A for biometric identification of the individual 12A, the network 110, and the computing environment 120. Turning first to the system 10, the system 10 includes the transmitter 20 and the receiver 40 for biometric identification of the individual 12. In one example, the transmitter 20 can be embodied as an embedded device including a combination of one or more processors, analog and/or digital processing circuits, memory devices, physical layer communications devices, input/output devices and related interfaces, and other related components, in discrete, integrated, or a combination of discrete and integrated forms. In the networked environment 100, the system 10A is similar to the system 10, but is relied upon for biometric identification of the individual 12A. Any number of biometric identification systems can be relied upon to identify any number of individuals in the networked environment 100.

The transmitter 20 can also be embodied, at least in part, in software, firmware, or a combination of software and firmware. The transmitter 20 can be implemented in a variety of different form factors. In one example, the transmitter 20 can be embodied as part of a laptop, a point of sale (POS) terminal, an automated teller machine (ATM), a door or access device, exercise equipment, or other type of device or infrastructure. In other examples, the transmitter 20 can be embodied in a wearable form factor, such as in a smartwatch, patch, strap, clothing (e.g., hats, shoes, gloves, eyewear, etc.), or other articles.

The receiver 40 can also be embodied as an embedded device including a combination of one or more processors, analog and/or digital processing circuits, memory devices, physical layer communications devices, input/output devices and related interfaces, and other related components, in discrete, integrated, or a combination of discrete and integrated forms. The receiver 40 can also be embodied, at least in part, in software, firmware, or a combination of software and firmware. The receiver 40 can also be implemented in a variety of different form factors, similar to those described above for the transmitter 20. In some cases, the transmitter 20 and the receiver 40 can be incorporated into the same infrastructure, device, or article, such as in the same POS or ATM terminals. In other cases, the transmitter 20 and the receiver 40 can be incorporated into different devices or articles, such as in two different arm or wristbands.

As shown in FIG. 2, the transmitter 20 includes a signal generator 23, a TX controller 24, a communications module 25, and device interfaces 26. The receiver 40 includes a signal receiver 43, an RX controller 44, a communications module 47, and device interfaces 48. The RX controller 44 includes an authentication engine 45 and a channel fingerprint memory 46. Although not shown in FIG. 2, the transmitter 20 and the receiver 40 can include other components not illustrated, such as batteries, display devices, user interfaces, sensors (e.g., heart rate, inertia, orientation, humidity, etc.), memory devices, etc. The operation of the components of the transmitter 20 and the receiver 40 are described in further detail below.

The network 110 is one example of a communications channel and can include the Internet, intranets, extranets, wide area networks (WANs), local area networks (LANs), wired networks, wireless networks, cable networks, satellite networks, other suitable networks, or any combinations thereof. As one example, one or more of the transmitter 20, the receiver 40, and the computing environment 120 can be respectively coupled to one or more public or private LANs or WANs and, in turn, to the Internet for communication of data among each other. Although not shown in FIG. 2, the network 110 can also include network connections to any number and type of network hosts or devices, such as website servers, file servers, cloud computing resources, databases, data stores, or any other network or computing architectures.

The computing environment 120 can include, for example, a server computer or any other system providing computing capability. Alternatively, the computing environment 120 can employ a plurality of computing devices that can be arranged, for example, in one or more server banks, computer banks, or other arrangements. Such computing devices can be located in a single installation or can be distributed among many different geographical locations. For example, the computing environment 120 can include a plurality of computing devices that together can include a hosted computing resource, a grid computing resource or any other distributed computing arrangement. In some cases, the computing environment 120 can correspond to an elastic computing resource where the allotted capacity of processing, network, storage, or other computing-related resources can vary over time.

The computing environment 120 can administer or interface with the system 10 as described below. Among other functions, the computing environment 120 can store a database of unique channel fingerprints for any number of individuals. The computing environment 120 can also perform one or more steps of authentication by biometric identification as described below.

In the networked environment 100, the transmitter 20, the receiver 40, and the computing environment 120 can communicate data among each other over the network 110 using one or more network transfer protocols or interconnect frameworks, such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), other protocols and interconnect frameworks, and combinations thereof.

Turning back to the system 10, the individual components and operations of the transmitter 20 and the receiver 40 are described, in turn. The signal generator 23 of the transmitter 20 can include a signal generator configured to generate and, in some cases, modulate or vary an electric signal over time. At the direction of the TX controller 24, the signal generator 23 can generate the signal for transmission through at least a portion of the body of the individual 12.

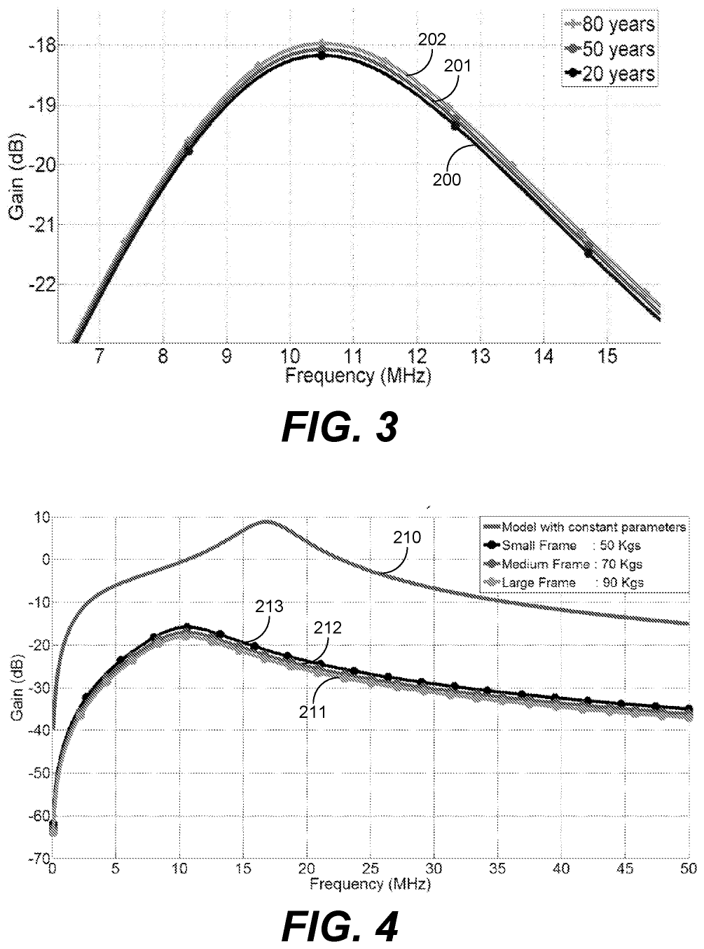

In one example, the signal generated by the signal generator 23 can be a sinusoidal signal at a particular frequency, amplitude, and level of power. In other examples, the signal can include a combination of two or more frequencies, including square, triangular, or other signal formats. In some cases, the signal can also vary in amplitude, frequency, power, or other characteristics over time. As one example, the signal can include a frequency sweep over a range, such as from direct current (or near 0 Hz) to 50 MHz or more, over a period of time. The range can be smaller or greater, including the example frequency ranges shown in FIGS. 3-7 and described below. Thus, the TX controller 24 can direct the signal generator 23 to generate the signal, and vary the signal over time, based on one or more factors. Depending upon the use case, the factors can be related to certain characteristics of the individual 12 (e.g., the height, weight, body mass index, heart rate, temperature, level of perspiration, etc. of the individual 12), the ambient environmental conditions, and based on other factors. The signal can be applied to the skin of the individual 12 through the electrodes 22.

The TX controller 24 is configured to monitor and oversee the operations of the signal generator 23, the communications module 25, and any other components of the transmitter 20. In that context, the TX controller 24 can direct the signal generator 23 to generate the signal for application to the skin of the individual 12 in a periodic, aperiodic, or continuous rate, or at the direction of commands or instructions received over the communications module 25. In some cases, the TX controller 24 can coordinate operations of the transmitter 20 with those of the receiver 40, based on direct wireless communications with the receiver 40 using the communications module 25. The TX controller 24 can also coordinate operations of the transmitter 20 based on communications or instructions received from the computing environment 120.

The TX controller 24 can be embodied, at least in part, as computer-readable instructions configured for execution on the transmitter 20. Thus, the TX controller 24 can be embodied as an application executing on a processor or processing circuitry of the transmitter 20, among other applications. The transmitter 20 can also execute a number of other applications in addition to that for the TX controller 24, such as applications typically executed by smart devices, including watches, smartphones, and other devices.

The communications module 25 can be embodied as physical layer communications hardware (e.g., cellular, WIFI®, BLUETOOTH®, or other communications interfaces) and is configured to perform wired or wireless communications with the communications module 47 of the receiver 40. The communications module 25 is also configured to perform wired or wireless communications with the computing environment 120 over the network 110. The transmitter 20 can interface with any number of devices outside the system 10 using the communications module 25.

The device interfaces 26 can include various peripheral devices or components of the transmitter 20. The peripheral devices can include input or communications devices or modules, such as keyboards, keypads, touch pads, touch screens, microphones, cameras, buttons, switches, or sensors. The sensors can include one or more temperature sensors, heart rate sensors, humidity or moisture sensors, oxygen level sensors, and other sensors to measure characteristics of the individual 12. The peripheral devices can also include a display, indicator lights, speakers, global positioning system (GPS) circuitry, accelerometers, gyroscopes, and other peripheral devices.

Turning to the receiver 40, the signal receiver 43 is configured to receive the signal generated by the signal generator 23 through the electrodes 42, after the signal has passed through the body of the individual 12. The signal receiver 43 can be embodied by one or more filters, low-noise amplifiers, and, in some cases, mixing and/or demodulation circuitry. Depending upon the implementation, the signal receiver 43 can mix the signal received through the electrodes 42 with a locally-generated signal, convert the signal into digital form for further processing by the RX controller 44, and take other actions to capture and process the signal for further evaluation by the RX controller 44.

The RX controller 44 is configured to monitor and oversee the operations of the signal receiver 43, the communications module 47, and any other components of the receiver 40. In some cases, the RX controller 44 can coordinate operations of the receiver 40 with those of the transmitter 20, based on direct wireless communications with the transmitter 20 using the communications module 47. The RX controller 44 can also coordinate operations of the receiver 40 based on communications or instructions received from the computing environment 120.

The RX controller 44 can be embodied, at least in part, as computer-readable instructions configured for execution on the transmitter 20. Thus, the RX controller 44 can be embodied as an application executing on a processor or processing circuitry of the receiver 40, among other applications. The receiver 40 can also execute a number of other applications in addition to that for the RX controller 44, such as applications typically executed by smart devices, including watches, smartphones, and other devices.

The RX controller 44 also includes the authentication engine 45 and the channel fingerprint memory 46. As noted above, the body of the individual 12 imparts a unique channel response on the signal generated by the signal generator 23 of the transmitter 20. The channel response can be relied upon by the receiver 40 to authenticate the identity of the individual 12. Because the transmitter 20 and the receiver 40 can communicate with each other using the communications modules 25 and 47, the receiver 40 can receive information related to the original characteristics of the signal generated by the signal generator 23 of the transmitter 20. The authentication engine 45 is configured to isolate or extract the channel response imparted by the individual 12 from, or as compared to, the original characteristics of the signal generated by the signal generator 23 of the transmitter 20. In other words, when the signal is received by the signal receiver 43 of the receiver 40 and provided to the RX controller 44, the authentication engine 45 is configured to extract the channel response from the signal. As a channel or communications pathway, the channel response exhibited by the body of the individual 12 can be different than conventional wired or wireless channels, but still offers a unique response that is static enough for the purpose of biometric identification. Additionally, the channel response exhibited by the individual 12 can be different, and unique, as compared to that of the individual 12A, among others.

The authentication engine 45 can extract the channel response in any suitable way using digital and/or analog processing techniques. The channel response developed by the authentication engine 45 can be a linear or non-linear, continuous or discrete, time-invariant or time-variant, real- or complex-valued response. The channel response may reflect, in part, noise, interference, distortion, attenuation, phase shift, group delay, path loss, fading, other channel effects, or combinations thereof. Any combination of one or more of these characteristics of the channel response can be relied upon as a channel fingerprint of the individual 12, for biometric identification. The authentication engine 45 is also configured to store the channel response in memory of the receiver 40 for further processing.

After the authentication engine 45 determines the channel response of the individual 12, the authentication engine 45 is also configured to perform a biometric challenge. For the biometric challenge, the authentication engine 45 can compare the channel response to one or more channel fingerprints stored in the channel fingerprint memory 46. The object of this comparison is to confirm (or refute) the identity of the individual 12 based on whether or not a sufficient match occurs between the detected channel response and one of the channel fingerprints.

The channel fingerprint memory 46 can include one or more channel fingerprints that uniquely identify a number of respective individuals. Among others, the channel fingerprint memory 46 can include a channel fingerprint for the individual 12. The channel fingerprints can be established or determined at any suitable time before a biometric challenge is performed. For example, a channel fingerprint for the individual 12 can be measured, extracted, and stored by the system 10 during a training or identity confirmation stage for the individual 12. Once established and stored, the channel fingerprint for the individual 12 can be relied upon to perform any number of biometric challenges at any time.

If the authentication engine 45 finds a sufficient match between the channel response and one of the channel fingerprints (e.g., to within a certain threshold or level of certainty), the authentication engine 45 can return a recognition indicator or response to the RX controller 44, confirming the identity of the individual 12. On the other hand, if the authentication engine 45 does not find a sufficient match, the authentication engine 45 can return a non-recognition indicator to the RX controller 44, indicating that the identity of the individual 12 is unconfirmed or unknown.

Based on the response from the authentication engine 45, the RX controller 44 can take additional actions. Among other actions, the RX controller 44 can perform one or more an additional or supplemental biometric challenges, provide one or more visual or audible indicators by the system 10, request input from the individual 12, or communicate data to confirm or refute the identification of the individual 12. As one example, the RX controller 44 can communicate with the computing environment 120 over the network 110, to inform the computing environment 120 of the results of the biometric challenge. As noted above, the system 10 can continuously or periodically authenticate the individual 12 without the need to interfere with the activities of the individual 12. The system 10 can also authenticate and re-authenticate the individual 12 while working, exercising, and conducting other activities, without interfering with those activities.

In some cases, the computing environment 120 can perform one or more of the functions of the authentication engine 45. The computing environment 120 can duplicate the functions of the authentication engine 45, or the computing environment 120 can perform the functions described above as being performed by the authentication engine 45, as an alternative to those functions being performed by the authentication engine 45. Thus, through one or more applications executing on the computing environment 120, the computing environment 120 can be configured to isolate or extract the channel response imparted by the individual 12 using data captured by the receiver 40. The computing environment 120 can extract the channel response using any suitable digital processing techniques. The computing environment 120 is also configured to store the channel response in a data store of the computing environment 120 for further processing.

The computing environment 120 is also configured to perform a biometric challenge. For the biometric challenge, the computing environment 120 can compare the channel response to one or more channel fingerprints stored in the data store of the computing environment 120. The data store of the computing environment 120 can store channel fingerprints for any number of individuals, including the individuals 12 and 12A, among others. The object of the comparison by the computing environment 120 is to confirm (or refute) the identity of the individual 12 based on whether or not a sufficient match occurs between the detected channel response and one of the channel fingerprints. If the computing environment 120 finds a sufficient match (e.g., to within a certain threshold or level of certainty), the computing environment 120 can return a recognition indicator or response to the transmitter 20 and/or receiver 40, confirming the identity of the individual 12. On the other hand, if the computing environment 120 does not find a sufficient match, it can return a non-recognition indicator to the transmitter 20 and/or receiver 40, indicating that the identity of the individual 12 is unconfirmed or unknown.

The system 10A is similar to the system 10, but can be relied upon for biometric identification of the individual 12A. The components of the system 10A can vary as compared to those of the system 10, based on manufacturing tolerances, the use of different components, the use of different electrodes, the use of different electrode positions, and other factors. As such, the channel response of the individual 12A, as measured by the system 10A, might vary as to one or more characteristics, as compared to that same channel response of the individual 12A if measured by the system 10. Thus, the channel fingerprint of the individual 12, when established by the system 10, may be unique to the system 10. In that case, the channel fingerprint of the individual 12, when established by the system 10, may not match with that measured by the system 10A. However, the system 10 and system 10A can be designed to capture the same, nearly the same, or a normalized channel response for a range of individuals. In that case, the channel fingerprint of the individual 12, when established by the system 10, can match (or pass a biometric challenge) when measured by the system 10A, and the converse can also hold. Similarly, the channel fingerprint of the individual 12A, when established by the system 10, can match (or pass a biometric challenge) when measured by the system 10A, and the converse can also hold.

When stored to memory in either the system 10, the system 10A, or in the computing environment 120, a channel fingerprint for an individual can include certain metadata. The metadata can include a unique identifier of the system (e.g., the system 10 or system 10A) used to capture the channel fingerprint of the individual. The metadata can also include a time and date of when the channel fingerprint was captured. The metadata can also include certain characteristics of the individual 12 (e.g., the height, weight, body mass index, heart rate, temperature, level of perspiration, etc. of the individual 12), the ambient environmental conditions during the capture, and other factors. The metadata can be used as a basis or factor in a biometric challenge or the results of the challenge.

FIG. 3 illustrates a transfer function of gain versus frequency for various ages of subjects for biometric identification according various embodiments described herein. FIG. 3 illustrates example, simulated results, showing the through-body communications channel sensitivity or gain against frequency, for three different age groups, including individuals in the age range of 20 years old at reference numeral 200, at the age range of 50 years old at reference numeral 201, and at the age range of 80 years old at reference numeral 202.

FIG. 4 illustrates a transfer function of gain versus frequency for various body frames of subjects for biometric identification according various embodiments described herein. FIG. 4 illustrates example, simulated results, showing the communications channel for a circuit model in which biological parameters are assumed to be constant at reference numeral 210. FIG. 4 also illustrates example, simulated results, showing the through-body communications channel sensitivity or gain against frequency, for three different frame sizes, including at 90 Kgs at reference numeral 211, at 70 Kgs at reference numeral 212, and at 50 Kgs at reference numeral 213. FIGS. 3 and 4 show how the channel response of the body of an individual depends on different features, both biological and geometrical, and is thus unique to each individual. The characteristics of this channel can therefore be used as a unique identifier for each individual.

A number of factors attributed to the electrodes 22 and 42 were also considered to study their impact on the channel response and model (e.g., the gain/attenuation profile and other characteristics). For example, the impact of varying different parameters related to the electrodes 22 and 42, such as area of the electrodes 22 and 42, the distance between the transmitter and the receiver electrodes 22 and 42, the material(s) of the electrodes 22 and 42, and the separation between each the electrodes 22 and 42 were investigated

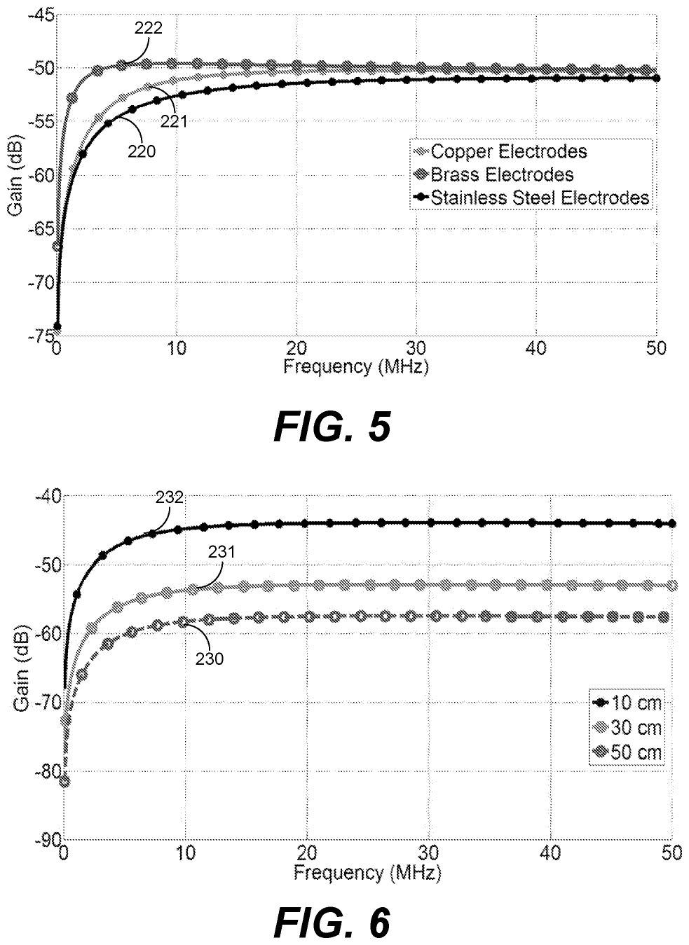

FIG. 5 illustrates a transfer function of gain versus frequency for various electrodes for biometric identification according various embodiments described herein. As shown, changing the material from which the electrodes 22 and 42 are fabricated, changes the characteristics of the channel behavior. The channel response for the use of stainless steel electrodes is shown at reference numeral 220. The channel response for the use of brass electrodes is shown at reference numeral 221, and the channel response for the use of copper electrodes is shown at reference numeral 220. Using different electrodes 22 and 42 is one example of how the components of the system 10A can vary as compared to those of the system 10.

FIG. 6 illustrates a transfer function of gain versus frequency for various electrode positions for biometric identification according various embodiments described herein. As shown, varying the distance between the transmitter electrodes 22 and the receiver electrodes 42 also impacts the channel response. As the distance increases, the channel gain drops (more attenuation). The channel response for a spacing of the electrodes 22 and 42 at 10 cm apart is shown at reference numeral 230, the channel response for a spacing at 30 cm apart is shown at reference numeral 231, and the channel response for a spacing at 50 cm apart is shown at reference numeral 232. Using different spacings of the electrodes 22 and 42 is another example of how the system 10A can vary as compared to the system 10.

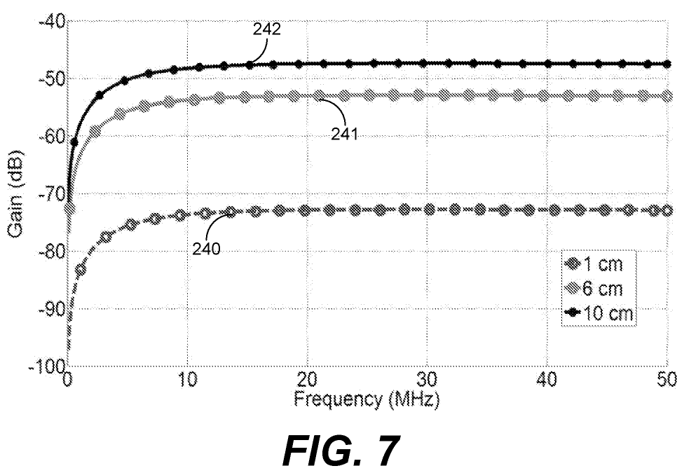

FIG. 7 illustrates a transfer function of gain versus frequency for various electrode positions for biometric identification according various embodiments described herein. As shown, the separation between the electrodes 22 impacts the channel response. Similarly, the separation between the electrodes 42 also impacts the channel response. The channel response for a spacing at 1 cm apart is shown at reference numeral 240, the channel response for a spacing at 6 cm apart is shown at reference numeral 241, and the channel response for a spacing at 10 cm apart is shown at reference numeral 242. Using different spacings among the electrodes 22 (and among the electrodes 42) is another example of how the system 10A can vary as compared to the system 10.

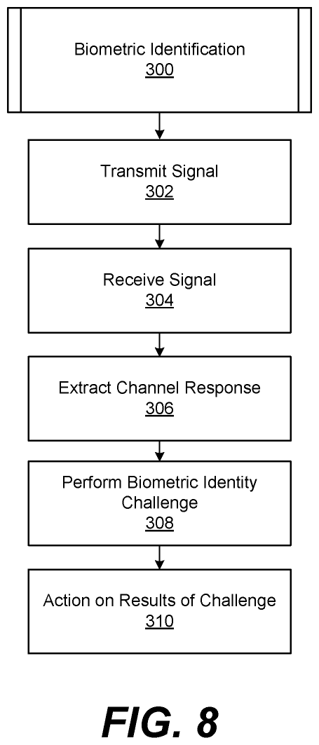

FIG. 8 illustrates a process 300 for biometric identification according various embodiments described herein. The process 300 is described in connection with the system 10 shown in FIG. 2, as an example, but the process 300 can be performed by similar systems and devices. The process 300 is not exhaustive in that it does not necessarily illustrate every step, and other steps can be relied upon at various points in the sequence. Additionally, the sequence of steps shown in FIG. 2 can be rearranged as compared to that shown in some cases, and one or more of the steps shown can be omitted in some cases.

At step 302, the process 300 includes transmitting a signal into a body of an individual at a first location on the body. For example, at the direction of the TX controller 24, the signal generator 23 of the transmitter 20 can generate a signal for transmission through at least a portion of the body of the individual 12. The signal can be applied to the electrodes 22 on the individual 12. The signal generated by the signal generator 23 can be a sinusoidal signal at a particular frequency, amplitude, and level of power. In other examples, the signal can include a combination of two or more frequencies, including square, triangular, or other signal formats. In some cases, the signal can also vary in amplitude, frequency, power, or other characteristics over time. As one example, the signal can include a frequency sweep over a range, such as from direct current (or near 0 Hz) to 50 MHz or more, over a period of time.

At step 304, the process 300 can include receiving the signal from the body of the individual at a second location on the body. For example, as directed by the RX controller 44 of the receiver 40, the signal receiver 43 can receive the signal generated by the signal generator 23 through the electrodes 42, after the signal has passed through the body of the individual 12. The signal receiver 43 can be embodied by one or more filters, low-noise amplifiers, and, in some cases, mixing and/or demodulation circuitry. Depending upon the implementation, the signal receiver 43 can mix the signal received through the electrodes 42 with a locally-generated signal, convert the signal into digital form for further processing by the RX controller 44, and take other actions to capture and process the signal for further evaluation by the RX controller 44.

At step 306, the process 300 can include extracting a channel response of the body from the signal received at step 304. For example, the authentication engine 45 of the receiver 40 can extract the channel response in any suitable way using digital and/or analog processing techniques. The channel response developed by the authentication engine 45 can be a linear or non-linear, continuous or discrete, time-invariant or time-variant, real- or complex-valued response. The channel response may reflect, in part, noise, interference, distortion, attenuation, phase shift, group delay, path loss, fading, other channel effects, or combinations thereof. Any combination of one or more of these characteristics of the channel response can be relied upon as a channel fingerprint of the individual 12, for biometric identification. The authentication engine 45 is also configured to store the channel response in memory of the receiver 40 for further processing.

At step 308, the process 300 can include performing a biometric identity challenge using the channel response. For the biometric challenge, the authentication engine 45 can compare the channel response obtained at step 306 to one or more channel fingerprints stored in the channel fingerprint memory 46. The object of this comparison is to confirm (or refute) the identity of the individual 12 based on whether or not a sufficient match occurs between the detected channel response and one of the channel fingerprints. The receiver 40 can perform the biometric challenge at step 308 one or more times, periodically over time, or continuously (or nearly continuously) over time.

At step 310, the process 300 includes acting on the results of the challenge performed at step 308. For example, if the authentication engine 45 finds a sufficient match (e.g., to within a certain threshold or level of certainty), the authentication engine 45 can return a recognition indicator or response to the RX controller 44, confirming the identity of the individual 12. On the other hand, if the authentication engine 45 does not find a sufficient match, the authentication engine 45 can return a non-recognition indicator to the RX controller 44, indicating that the identity of the individual 12 is unconfirmed or unknown.

The RX controller 44 can also perform one or more an additional or supplemental biometric challenges at step 310, provide one or more visual or audible indicators by the system 10, request input from the individual 12, or communicate data to confirm or refute the identification of the individual 12. The RX controller 44 can also communicate with the computing environment 120 over the network 110 at step 310, to inform the computing environment 120 of the results of the biometric challenge.

In some cases, the computing environment 120 can perform one or more of the steps shown in FIG. 8, such as steps 306, 308, and 210. The computing environment 120 can duplicate the functions of the receiver 40, or the computing environment 120 can perform the functions in place of or instead of the receiver 40. Thus, through one or more applications executing on the computing environment 120, the computing environment 120 can perform one or more of the steps shown in FIG. 8, such as steps 306, 308, and 210.

The flowchart in FIG. 8 shows examples of the functions and operations of the components described herein. The components described herein can be embodied in hardware, software, or a combination of hardware and software. If embodied in software, each element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The transmitter 20 and the receiver 40 can each include at least one processing circuit. Such a processing circuit can include, for example, one or more processors and one or more storage or memory devices coupled to a local interface. The local interface can include, for example, a data bus with an accompanying address/control bus or any other suitable bus structure. The storage or memory devices can store data or components that are executable by the processors of the processing circuit. For example, the TX controller 24, the RX controller 44, and/or other components can be stored in one or more storage devices and be executable by one or more processors in the system 10.

The transmitter 20, the receiver 40, and/or other components described herein can be embodied in the form of hardware, as software components that are executable by hardware, or as a combination of software and hardware. If embodied as hardware, the components described herein can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein, including the TX controller 24, the RX controller 44, and/or other components can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

1. A system for biometric identification, comprising:
a biometric transmitter device comprising at least one transmit electrode for contact with skin of an individual at a first location on the skin, the biometric transmitter device being configured to transmit a signal through the transmit electrode and the skin; and
a biometric receiver device comprising at least one receive electrode for contact with the skin of the individual at a second location on the skin, the biometric receiver being configured to receive the signal through the receive electrode for biometric authentication of the individual.

2. The system according to claim 1, wherein the biometric receiver device further comprises an authentication engine configured to extract a channel response from the signal.

3. The system according to claim 2, wherein the authentication engine is further configured to compare the channel response to at least one channel fingerprint.

4. The system according to claim 3, wherein the authentication engine is further configured to communicate a result of a comparison between the channel response and the at least one channel fingerprint over a communications channel.

5. The system according to claim 3, wherein the authentication engine is further configured to compare the channel response to the at least one channel fingerprint on a periodic basis.

6. The system according to claim 3, wherein the authentication engine is further configured to confirm an identity of the individual based on a determination of a sufficient match between the channel response and the at least one channel fingerprint.

7. The system according to claim 3, wherein the authentication engine is further configured to refute an identity of the individual based on a determination of an insufficient match between the channel response and the at least one channel fingerprint.

8. The system according to claim 1, wherein the system is embodied in a wearable form factor.

9. The system according to claim 1, wherein the system is embodied in at least one of a point of sale (POS) terminal, an automated teller machine (ATM), or an access device.

10. The system according to claim 1, wherein the signal comprises a frequency sweep over a range of frequencies during a period of time.

11. A process for biometric identification, comprising:
transmitting a signal into a body of an individual at a first location on the body;
receiving the signal from the body of the individual at a second location on the body, wherein the body of the individual imparts a unique channel response on the signal; and
extracting a channel response of the body from the signal.

12. The process according to claim 11, further comprising performing a biometric identity challenge using the channel response.

13. The process according to claim 12, further comprising communicating a result of the biometric identity challenge over a communications channel.

14. The process according to claim 11, further comprising performing a biometric identity challenge by comparing the channel response against at least one channel fingerprint stored in memory.

15. The process according to claim 14, wherein performing the biometric identity challenge further comprises, based on a determination of a sufficient match between the channel response and the at least one channel fingerprint, confirming an identity of the individual.

16. The process according to claim 14, wherein performing the biometric identity challenge further comprises, based on a determination of an insufficient match between the channel response and the at least one channel fingerprint, refuting an identity of the individual.

17. The process according to claim 13, wherein the signal comprises a frequency sweep over a range of frequencies during a period of time.

18. A biometric identification device, comprising:
at least one receive electrode for contact with skin of an individual;
a signal receiver configured to receive a signal through the receive electrode; and
an authentication engine configured to:
extract a channel response from the signal; and
compare the channel response to at least one channel fingerprint for biometric authentication of the individual.

19. The device according to claim 18, wherein the authentication engine is further configured to communicate a result of a comparison between the channel response and the at least one channel fingerprint over a communications channel.

20. The device according to claim 18, wherein the authentication engine is further configured to compare the channel response to the at least one channel fingerprint on a periodic basis.
